(19) United States
(12) Patent Application Publication
(10) Pub. No.: US 2017/0017982 A1
(43) Pub. Date: Jan. 19, 2017

(54) SYSTEM AND METHOD OF PROVIDING AN INFORMATION TECHNOLOGY SERVICES REPORT

(71) Applicant: Keith Douglas Trippie, Manassas, VA (US)

(72) Inventor: Keith Douglas Trippie, Manassas, VA (US)

(21) Appl. No.: 15/198,454

(22) Filed: Jun. 30, 2016

Related U.S. Application Data
(60) Provisional application No. 62/191,877, filed on Jul. 13, 2015.

(51) Int. Cl. G06Q 30/02; H04L 12/26; G06F 17/30; H04L 29/08

(52) U.S. Cl. CPC G06Q 30/0218; H04L 67/02; H04L 43/06; H04L 67/36; G06F 17/30867; G06F 17/3053; G09B 7/00

(57) ABSTRACT

A system and method of providing an Information Technology (IT) services report to a user is provided. The present invention includes a database and a server, such as a web server. The server may include a microprocessor and a memory having a loaded software. The server produces a plurality of questions formulated to extract IT related needs of the user. A plurality of search criteria is extracted from answers to the plurality of questions. A proprietary algorithm compares and matches the plurality of search criteria with IT products and services data of a plurality of IT services stored on the database. A report is then produced and displayed to the user. The report may include a list of IT services that match with the criteria. Each of the IT services on the list may include comparison data including at least a vendor name and a price.

### CROSS-REFERENCE TO RELATED APPLICATION

This application claims the benefit of priority of U.S. provisional application No. 62/191,877, filed Jul. 13, 2015, the contents of which are herein incorporated by reference.

### BACKGROUND OF THE INVENTION

The present invention relates to a system and method for matching users with information technology services and issuing the users points and badges based on their interactions with the system.

The cloud and information technology (IT) marketplace is vast, complex and dynamic. Commercial, academic and government employees that need cloud and IT services have difficulty keeping up with the ever changing cloud and IT service offerings available on the market, compliance requirements and which cloud will meet their needs. To attempt to gain knowledge regarding up to date cloud and IT services, a user must pay for expensive consultants, conduct arduous research or talk to the myriad of cloud service providers and integrations to conduct their assessment of which cloud or IT service meets their needs. The current process is expensive, time consuming and very risky to their entity's mission. This paradigm drives up costs, risks to selecting the wrong IT product or service and prolongs the decision making process for both users and management functions within organizations; negatively impacting the organization's business outcomes.

Further, there is no standard of pricing or measurement within the cloud and IT industry. Each cloud and IT service provider has a different way to price, offer service levels, compliance, security, privacy, legal, etc. Because this information is proprietary and different across industries, states and countries, business users have no easy way of shopping for cloud services.

Additionally, cloud providers, system integrators and IT companies are in need of data about companies buying cloud services so they can better target future services to company's needs.

As can be seen, there is a need for a system and method of matching users with cloud and IT services.

### SUMMARY OF THE INVENTION

In one aspect of the present invention, a method of providing an Information Technology (IT) services and products report to a user or third party comprises the steps of: producing a plurality of questions via software running on the computer, wherein the plurality of questions are formulated to extract IT related needs of the user; extracting a plurality of search criteria from answers to the plurality of questions via software running on the computer; comparing and matching the plurality of search criteria with IT products and services data of a plurality of IT services stored on a database via software running on the computer; and producing a report comprising a list of IT products and services that match with the criteria via software running on the computer, wherein the report further comprises comparison data and social media analytics data comprising at least a vendor name and a price for each of the services listed.

In another aspect of the present invention, a system of providing an Information Technology (IT) services report to a user comprises: a database comprising IT services data of a plurality of IT services; a web server operable to access the database and comprising a microprocessor and a memory, wherein microprocessor produces a plurality of questions formulated to extract IT related needs of the user; extracts a plurality of search criteria from answers to the plurality of questions; compares and matches the plurality of search criteria with the IT services data of the plurality of IT products and services stored on the database; and produces a report comprising a list of IT services that match with the criteria, wherein the report further comprises comparison data comprising at least a vendor name and a price for each of the services listed. The report can be printed, saved and rated by the user. The system generates user points which the user can then redeem for rewards. The system logs all user transactions and will issue gamification badges to the users. The system captures the user transaction data and provides customer intent, market intelligence data which can then be extracted and shared with 3^{rd} party companies.

These and other features, aspects and advantages of the present invention will become better understood with reference to the following drawings, description and claims.

### BRIEF DESCRIPTION OF THE DRAWINGS

FIG. 1 is a schematic view of an embodiment of the present invention;

FIG. 2 is a flow chart of a method of an embodiment of the present invention;

FIG. 3 is a continuation of the flow chart of FIG. 2; and

FIG. 4 is a flow chart of a back end process of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser.

The computer may access the software via the web browser using the internet, extranet, intranet, host server, internet cloud and the like.

The present invention includes software in the form of a web based application or a web server. The present invention prompts users to answer a series of questions about their Information Technology (IT) needs. The present invention then provides the user with comparisons and recommendations of IT services based on the answers, which allows the user to properly shop for IT services. The present invention also provides reporting, analytics and user earned points for executing transactions on the web server, such as executing new searches on the web server, providing referrals and saving their searches.

The present invention provides an easy to use service that quickly and efficiently matches users with cloud and IT services. Within minutes, users can easily answer questions based on their technical or non-technical background, and receive comparisons, recommendations and analysis of the current IT services marketplace. Using the present invention, users can reduce the risk, costs and time associated with assessing which IT services best meet their needs. Further, the present invention allows the user to receive points which they can redeem at a later date. The user may receive points each time a report is generated. These user points are then converted to rewards which the users can redeem for shopping gift cards. These user points are also converted to gamification badges which demonstrate user proficiency in new technologies such as IT pioneers, IT beginner, IT guru, etc. The points are may be converted into badges at certain point threshold totals.

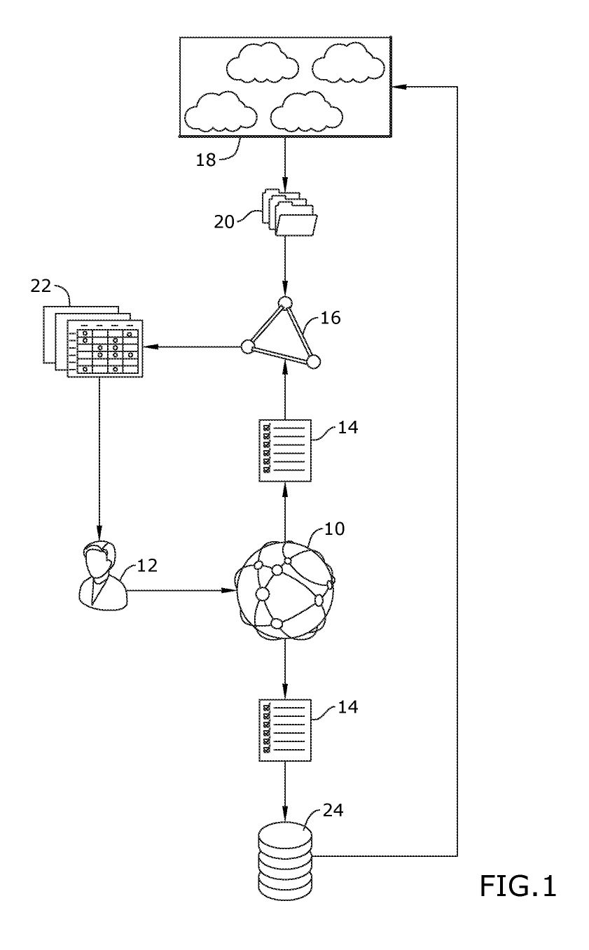

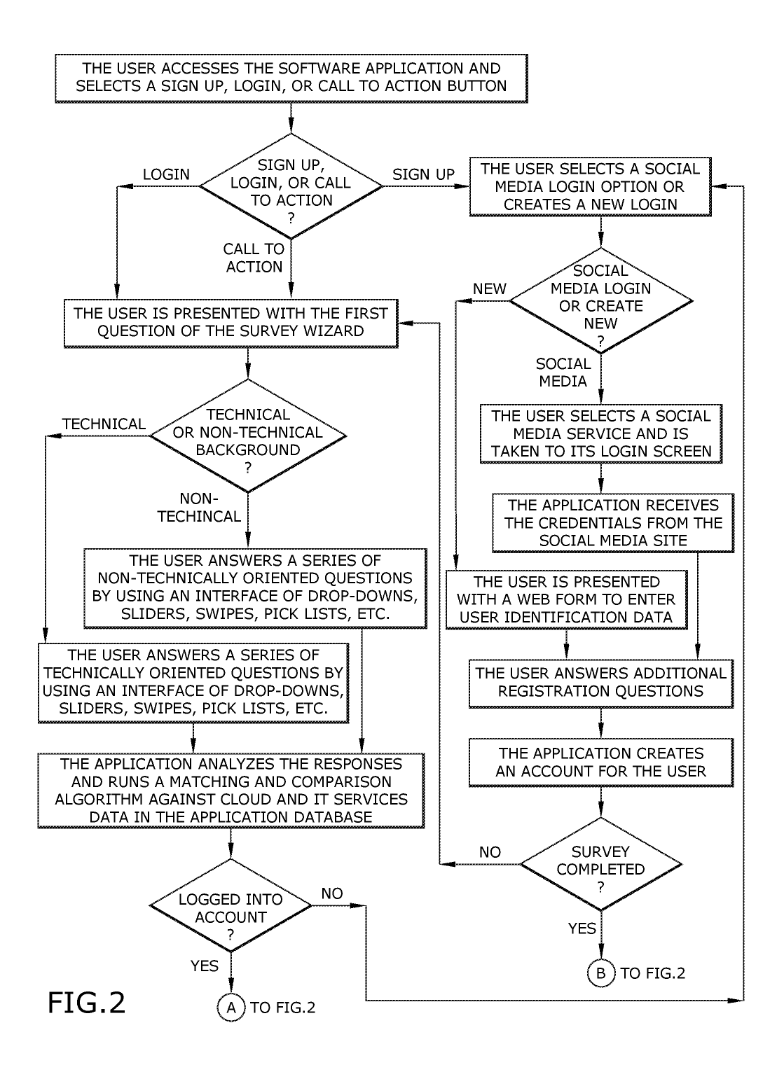

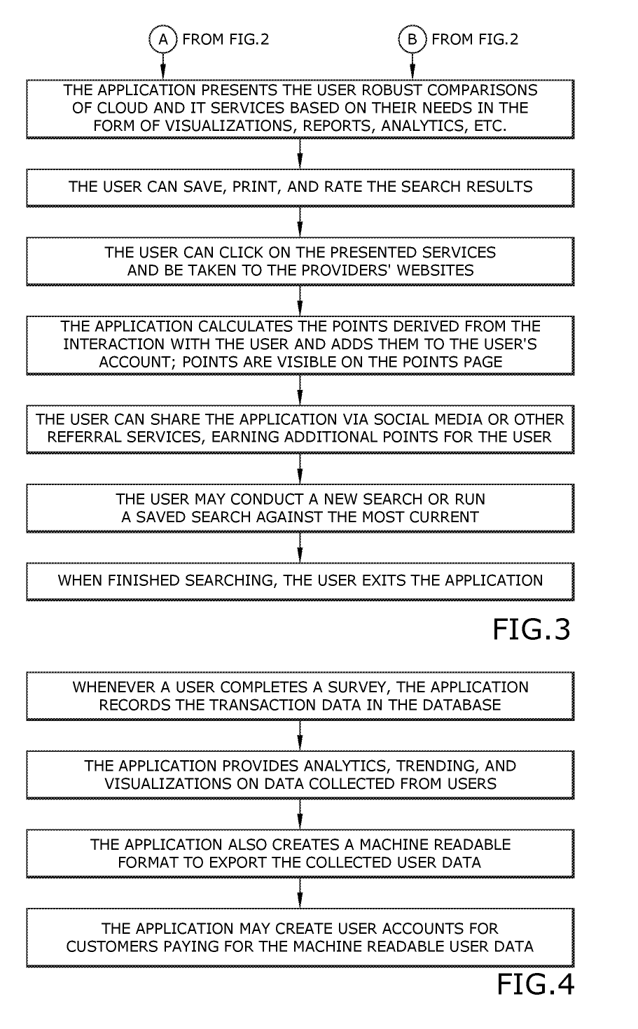

Referring to FIGS. 1 through 4, the present invention includes a system and method of providing an Information Technology (IT) services report to a user 12. The present invention includes a database 24 and a server 10, such as a web server. The server 10 may include a microprocessor and a memory having a loaded software. The server 10 produces a plurality of questions formulated to extract IT related needs of the user 12. A plurality of search criteria 14 is extracted from answers to the plurality of questions. A proprietary algorithm 16 compares and matches the plurality of search criteria 14 with IT services data 20 of a plurality of IT services 18 stored on the database 24. IT data and services information is added to the database via a Application Program Interface (API) and via web scraping and web services methods. A report 22 is then produced and displayed to the user 12. The report 22 may include a list of IT services 18 that match with the criteria. Each of the IT services 18 on the list may include comparison data including at least a vendor name and a price.

In certain embodiments, the present invention simplifies the shopping process for cloud and IT services by producing questions that are tailored to the background of the shopper (user). In such embodiments, the user 12 is prompted to enter data indicating whether the user has a technical background or a non-technical background prior to the microprocessor producing the plurality of questions. The microprocessor then formulates the plurality of questions based on whether the user 12 has a technical background or not. In such embodiments, a non technical user is presented with questions that are more business focused and a technical user is presented with more technical based questions.

The user may select answers via different user interface formats, such as, but not limited to, drop downs, sliders, swipes, pick lists and the like. In certain embodiments, the IT services 18 includes cyber products, data center services, software products, telecommunication products and services and cloud based services. When shopping for IT products and services, the user 12 may be asked what type of IT product or service they are shopping for. To determine the user's technical background, the user may be asked to select their professional background from a drop down menu. The server 10 then produces a plurality of questions formulated to extract IT related needs of the user 12. For example, the user may then be asked: to rank an order of importance of their particular project, such as reducing costs, improving security, improving performance, and whether they need a new capability; the type of solution they are shopping for; who the end user of the solution is; where the user is located; how many users will be using the system per day; whether there are any surge seasons; whether they will be migrating from an existing system; whether the solution needs to communicate with other current systems; what are the compliance and security requirements of the user; and the like. For a more technical user, the questions may include technical questions including questions about a customer's current hosting environment, business requirements, and contracts with other IT providers, security and compliance needs and the like.

After answering the questions, but prior to receiving the report 22, the present invention may prompt the user 12 to sign up for the service. In such embodiments, the user 12 may select a social media login option or create a new login. If the user 12 selects a social media login, the present invention receives the credentials (identifying information) of the user 12 from the social media platform. If the user 12 selects create a new login, the user 12 may answer a series of questions that extract the identifying information of the user 12. The user 12 then creates the login account and is able to view the report 12.

The report 22 of the present invention may present users 12 with robust comparison analysis visualizations. The comparison data and recommendation results may include, but is not limited to, a score against sub criteria such as business needs, security/compliance, and budget, the latest pricing, compliance requirements, social media analysis, IT products, services or cloud features and benefits to help a consumer quickly find the best comparisons across the cloud marketplace. In certain embodiments, the report 22 may include a rank of IT services 18 based on how close the IT services 18 matched with the plurality of search criteria 14. Further, in certain embodiments, the results report 22 may include URL links so that the user may click on the cloud or IT services vendor and the user is then presented with the cloud or IT services vendor's website.

The present invention allows the user to save, print and rate search results. Each of the actions may award points to the user. The points accrued by each user can be redeemed for rewards, including gift cards, at certain point thresholds. For some customers, including government, the system will convert user points into badges which will demonstrate a proficiency levels with new technologies. This is a high value feature for both the user as well as the management of an organization. The user may share the results with other potential users via social networks or via a referral service. The present invention captures the sharing transaction and provides points to the user's point service. The present invention then calculates the points derived from the customer's interaction with the system.

As mentioned above, the database 24 of the present invention may include IT products and services data 20 of a plurality of IT services 18. In certain embodiments, the IT products and services data 20 of the database 24 is periodically updated for each of the plurality of IT services 18 via software running on a computer. For example, data, such as the price and the specifications, of the IT service may be updated regularly. In such embodiments, the user 12 may re-run old saved searches or new searches and the comparison proprietary algorithm 16 may thereby update the results to reflect the changing marketplace.

In certain embodiments, the system records each user search and transaction within the database 24. The system may thereby provide analytics, trending and visualizations on collected user data. The system may also create a machine readable format to export or distribute the data collected on the user's transactions within the database 24. IT companies and organizations can use the customer intent shopping information, to help them better tailor products and services to current and future customers; improving their business outcomes and objectives. Further, IT companies and organizations benefit from using the present invention by embedding the software within their service offerings which may help their customers easily shop for cloud and IT services offered through their entity.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of providing an Information Technology (IT) services report to a user comprising the steps of:
producing a plurality of questions via software running on the computer, wherein the plurality of questions are formulated to extract IT related requirements of the user;
extracting a plurality of search criteria from answers to the plurality of questions via software running on the computer;
comparing and matching the plurality of search criteria with IT products and services data of a plurality of IT services stored on a database via software running on the computer; and
producing a report comprising a list of IT products and services that match with the criteria via software running on the computer, wherein the report further comprises comparison and recommendation data comprising at least a vendor name and a price for each of the services listed.

2. The method of claim 1, wherein the IT products and services data of the database is periodically updated for each of the plurality of IT products and services via software running on a computer.

3. The method of claim 1, wherein the list of IT services comprises a rank illustrating the IT services that matched closest to the plurality of search criteria.

4. The method of claim 1, wherein the comparison data further comprises compliance requirements, social media analysis, IT products and services features and benefits.

5. The method of claim 1, wherein the IT services comprises cloud services, telecommunications, cyber, data center services, software, solutions and hardware.

6. The method of claim 1, further comprising the step of:
prompting a user to enter data indicating whether the user has a technical background or a non-technical background prior to the step of producing the plurality of questions, via software running on a computer, wherein the plurality of questions are based on the entered data.

7. The method of claim 1, further comprising the step of:
prompting a user to sign up by entering indentifying information prior to the step of producing the report via software running on a computer.

8. The method of claim 1, further comprising the step of:
awarding the user points each time a new report, search performed, referral, rating and saving search results are generated.

9. The method of claim 8, wherein an amount of points are tallied for each user and each user is awarded either award redemption points or types of badge based on the amount of points.

10. The method of claim 8, wherein an amount of points are tallied for each user and each user is awarded redemption awards such as gift cards or type of badge based on the amount of points.

11. A system of providing an Information Technology (IT) services report to a user comprising:
a database comprising IT products and services data of a plurality of IT services;
a web server operable to access the database and comprising a microprocessor and a memory, wherein microprocessor
produces a plurality of questions formulated to extract IT related needs of the user;
extracts a plurality of search criteria from answers to the plurality of questions;
compares and matches the plurality of search criteria with the IT products and services data of the plurality of IT services stored on the database; and
produces a report comprising a list of IT services that match with the criteria, wherein the report further comprises comparison data comprising at least a vendor name and a price for each of the services listed.

12. The system of claim 11, wherein the IT services data of the database is periodically updated, via API, web services and web scraping methods for each of the plurality of IT services via software running on a computer.

13. The system of claim 11, wherein the list of IT services comprises a rank illustrating the IT services that matched closest to the plurality of search criteria.

14. The system of claim 11, wherein an amount of points are tallied for each user and each user is awarded a type of badge based on the amount of points.

15. The system of claim 11, wherein the IT services comprises cloud services, telecommunications, cyber, data center services, software, solutions and hardware.

16. The system of claim 11, wherein the microprocessor
prompts a user to enter data indicating whether the user has a technical background or a non-technical background prior producing the plurality of questions, wherein the plurality of questions are based on the entered data.

17. The system of claim 11, wherein the microprocessor
prompts a user to register and sign in entering identifying information prior to producing the report.

18. The system of claim 11, wherein the microprocessor
awards points to the user each time a new report is generated.

19. The method of claim 18, wherein an amount of points are tallied for each user and each user is awarded a type of badge based on the amount of points.

20. The method of claim 18, wherein an amount of points are tallied for each user and the user exchanges the points for monetary rewards.
